(19) United States
(12) Patent Application Publication
(10) Pub. No.: US 2026/0175175 A1
(43) Pub. Date: Jun. 25, 2026

(54) MINIMAL LIQUID DISCHARGE DESALINATION SYSTEMS USING INTEGRATED MEMBRANE PROCESSES

(71) Applicant: Blue Planet Technologies WLL, Al Juffair (BH)

(72) Inventor: Salah ALBURAIDI, Al Juffair (BH)

(21) Appl. No.: 19/125,124

(22) PCT Filed: Nov. 2, 2022
(86) PCT No.: PCT/IB2022/060553

§ 371 Date: Apr. 28, 2025

(51) Int. Cl. B01D 61/58; B01D 61/02; B01D 61/18

(52) U.S. Cl. CPC B01D 61/58; B01D 61/027; B01D 61/18

(57) ABSTRACT

A saline water pre-treatment or treatment system using nanofiltration and forward osmosis; the system comprising: a feed solution, a first and second pressure pump, a separation module, a forward osmosis module, and a reverse osmosis module.

### FIELD OF THE DISCLOSURE

The present disclosure relates to integrated systems for saline water treatment using nanofiltration, forward osmosis and reverse osmosis.

### BACKGROUND

Due to ongoing population growth, rising living standards and requirements, and the development of industrial and agricultural operations, the need for clean water has been increasing globally at a fast rate. In order to meet the growing demands of fresh water, research has been performed on brackish water and seawater desalination technologies to convert it in to usable forms. Known methods of water treatment and pre-treatment include nanofiltration, NF; thermal desalination; forward osmosis, FO; and reverse osmosis, RO. Nanofiltration separates divalent ions from feed solutions using a nanofiltration membrane. Small molecules such as water molecules flow through the NF membrane while divalent ions are rejected. NF typically only gives divalent ion rejection of 75-99%, and monovalent ion rejection of 30-50%. As a result, NF alone is insufficient to reduce total dissolved salts levels in saline water to the World Health Organization's permitted limit of 500 ppm.

Forward osmosis, FO, uses the difference in osmotic pressure between two solutions separated by a semipermeable membrane to give the transport of water molecules. The hydraulic pressure applied on both sides of the membrane is equal. Water molecules flow from the less concentrated solution side to the more concentrated solution side until an equilibrium state is reached. FO requires a feed solution and a draw solution.

FO cannot be operated as a standalone process to extract pure water and must be combined with other desalination systems to recover the draw solution.

Reverse osmosis, RO, uses hydraulic pressure to give the transport of water molecules across a semipermeable membrane. The hydraulic pressure applied on feed side only. Thus, water molecules flow from a more concentrated feed side to a lower concentration permeate side.

Osmotic pressure assisted reverse osmosis uses a combination of RO and FO components connected in series. In the RO component, the hydraulic pressure of a feed solution is higher than the hydraulic pressure of a permeate side and water molecules are transported from the feed side to the permeate side. In the FO component, the hydraulic pressure of both sides is equal and water molecules are transported from the low concentration side to the high concentration side due to the difference in osmotic pressure.

The semipermeable membranes used in osmotic processes are susceptible to scaling and fouling from divalent ions in saline water. Ions such as calcium, magnesium, sulfates and bicarbonates limit the life span or reliability of FO and RO membranes by forming a scaling and fouling layer on the membrane surface.

Thermal desalination methods can also be used to treat saline water. Thermal desalination involves evaporating the water of feed solution in order to separate pure water from the salts of the feed solution.

One of the major hurdles for the widespread use of thermal or membrane-based desalination technologies is the comparatively high energy requirements and production costs of the technologies.

Desalination processes often produce treated water and large volumes of waste solutions. The disposal of the waste solutions in the sea has negative environmental impacts including an adverse effect on marine life.

Aspects of the present disclosure seek to provide a saline water treatment system that alleviates these problems with prior known systems. In particular, aspects of the present disclosure seek to provide a saline water treatment system with improved water recovery yield and/or an improved saline water treatment system with lower energy requirements.

### SUMMARY

According to a first aspect of the present disclosure, there is provided a saline water treatment system comprising: an inlet for receiving a feed solution, a first pressure pump for delivering the feed solution to a separation module, a forward osmosis, FO, module, a second pressure pump, and a reverse osmosis, RO, module; the separation module comprising an inlet for receiving the feed solution from the first pressure pump, a membrane defining a permeate portion and a reject portion of the module, a first outlet in the permeate portion and a second outlet in the reject portion; the FO module comprising a first and second portion separated by a semipermeable membrane, wherein each portion of the FO module comprises an inlet and an outlet; wherein the system is configured to separate the feed solution in the separation module into a permeate solution with a reduced ion concentration and a reject solution with an increased ion concentration, the reject solution leaving the separation module at a higher hydraulic pressure than the permeate solution due to the assistance of hydraulic pressure applied at the first pressure pump; wherein the system is further configured to deliver a first solution to the first portion of the FO module and to deliver the reject solution from the separation module to the second portion of the FO module, to facilitate the transport of water molecules across the semipermeable membrane from the second portion to the first portion; wherein the system is configured to output a FO permeate solution from the first portion of the FO module and a concentrated FO reject solution from the second portion of the FO module; and wherein the system is further configured to deliver the FO permeate solution via a second pressure pump to the RO module, the RO module comprising an inlet for receiving the FO permeate solution, a RO membrane defining a RO reject portion and a RO permeate portion of the RO module, a first outlet in the RO reject portion and a second outlet in the RO permeate portion.

In this way, the FO module integrates the RO system. The separation in the FO module takes place based on the combined effect of the hydraulic pressure and the osmotic pressure. The FO separation has lower pressure requirements than RO and therefore gives a treatment system with lower energy requirements. The system uses minimal pressure pumps. In this way, the net energy consumption of the system is much lower than standalone RO systems with high water productivity.

The introduction of the separation module before the FO module gives a reduction in the hardness content of the feed under separation. Therefore, the permeate solution from the first separation module has a less scaling and fouling effect on the subsequent FO and RO membrane processes.

The reject solution from the separation module is reused in the system in order to extract more water from the feed solution. The system provides a pure water recovery yield of 49.56%.

The use of an RO module in combination with the separation and FO modules allows the system to provide high quality water which meets World Health Organisation, WHO, standards (TDS 500 ppm) from a seawater feed solution with a total dissolved salts, TDS, of approximately 35,380 ppm.

The system produces low volumes of reject solution to be discharge, reducing the environmental impact of the desalination process. The discharged reject solution has a salinity of up to 220 000 ppm. Therefore the discharged reject solution can be suitable for mineral extraction a zero liquid leading to discharge process.

In some embodiments, the separation module is a nanofiltration, NF, module; the NF module comprising an inlet for receiving the feed solution from the first pressure pump, a NF membrane defining a NF permeate portion and a NF reject portion of the NF module, a first outlet in the NF permeate portion, and a second outlet in the NF reject portion.

In some embodiments, the separation module is a RO module, the RO module comprising an inlet for receiving the feed solution, a RO membrane defining a RO reject portion and a RO permeate portion of the RO module, a first outlet in the RO reject portion and a second outlet in the RO permeate portion.

In some embodiments, the first solution delivered to the first portion of the FO module is the permeate solution from the separation module. In this way, the permeate solution of the separation module is further treated to improve the water recovery of the system.

In some embodiments, the RO reject solution is delivered to the second portion of the FO module. In this way, both the separation module reject solution and the RO module reject solution are delivered to the FO module and the water recovery of the system is increased.

In some embodiments, the system further comprises a second FO module, the second FO module comprising a first and second portion separated by a semipermeable membrane, wherein each portion of the FO module comprises an inlet and an outlet. In some embodiments, the first portion of the second FO module is configured to receive the FO permeate solution from the first FO module and the second portion of the second FO module is configured to receive the reject solution from the RO module. In this way, the pure water recovery of the system may be increased to 55.65%.

In some embodiments, the system further comprises a second separation module located before the first separation module, the second separation module comprising a membrane defining a permeate portion and a reject portion of the module, a first outlet in the permeate portion and a second outlet in the reject portion, the second separation module configured to separate the feed solution into a permeate solution and a reject solution, and wherein the reject solution of the second separation module is delivered to the inlet of the first separation module. In some embodiments, the second separation module is a RO module. In this way, the pure water recovery of the system may be increased to 57.82%. In some embodiments, the second separation module is a NF module.

In some embodiments, the system comprises an NF module, the NF module comprising an inlet, a NF membrane defining a NF permeate portion and a NF reject portion of the NF module, a first outlet in the NF permeate portion, and a second outlet in the NF reject portion; wherein the system is configured to deliver the FO reject solution to the NF module, the NF module is configured to separate the FO reject solution into a NF reject solution and a NF permeate solution, and the system is configured to deliver the NF permeate solution to the first portion of the FO module. In this way, the pure water recovery of the process may be increased to 62.6%.

In some embodiments, the feed solution comprises at least one selected from the group consisting of: seawater, brackish water, industrial sewage water, domestic sewage water, storm sewage water, produced water, and oil field produced water. In this way, water recovery of natural or waste saline water can be obtained. In some embodiments, the feed solution consists of seawater.

In some embodiments, the system further comprises a valve configured to allow the controlled bypass of modules by the permeate solutions. In this way, permeate solutions can be extracted from the system at an earlier stage depending on the requirements of the user. In some embodiments, the system further comprises more than one valve configured to allow the controlled bypass of further separation modules by the permeate solutions. In this way, permeate solutions can be extracted from more than one location during the desalination process depending on the requirement of the user.

In some embodiments, the system comprises a low pressure pump configured to deliver the solution to the first portion of the first and/or second FO module at a reduced pressure. In this way, the hydraulic pressure gradient in the FO modules can be increased in order to increase the transport of water molecules from the second portion to the first portion of the FO modules.

In some embodiments, the system further comprises: a first tank, a second tank, a high pressure pump, a low pressure pump, a pair of FO modules comprising a second FO module and a third FO module, and a pressure control valve; wherein the system is configured to: deliver the FO permeate solution from the first FO module to the first and second tanks; deliver the solution from the first tank via the high pressure pump to the RO module at an increased hydraulic pressure, and deliver the solution from the second tank via the low pressure pump to the second portion of the second FO module at a reduced pressure; deliver the RO reject solution to the first portion of the second FO module, deliver the reject solution from the second FO module to the first portion of the third FO module; deliver the reject solution of the third FO module to the second portion of the third FO module via the pressure control valve, the pressure control valve configured to lower the pressure of the solution; and deliver the reject solution of the third FO module to the first tank. In this way, the system can achieve a pure water recovery of 68.6%. Additionally, in this way, the concentration of the reject solution discharged from the system is increased. The concentrated discharged solution favours a mineral extraction process which can lead to a zero liquid discharge process.

In some embodiments, the system further comprises one or more additional pairs of FO modules. In this way, the pure water recovery of the system can be further increased to up to 80.28%. As the number of pairs of FO modules increases, the water recovery of the system increases. Additionally, the concentration of the reject solution discharged from the system may be further increased.

In some embodiments, the system comprises a single feed stream. In this way, the single feed stream can be treated without the need for any additional feed streams or draw solutions.

In some embodiments, the system comprises a single reject output stream. In this way, the system provides a single concentrated solution to be discharged. In this way the environmental impact of the process can be reduced.

In some embodiments, the system may be combined with a mineral extraction process. In this way, the system may provide for a zero liquid discharge process which reduces negative impacts on the environment.

In some embodiments, the NF module can be operated in the low pressure range of 20-40 bar. In this way, the energy requirements of the saline water pre-treatment or treatment system are reduced. In alternative embodiments, the NF module can be operated in the high pressure range of 60-80 bar.

In some embodiments, the RO module can be operated in the pressure range of 70 to 80 bar.

In some embodiments, the system further comprises a pre-treatment module configured to process the feed solution. In this way, fouling of the semipermeable FO module membranes can be reduced and the water recovery yield of the system can be increased.

In some embodiments, the geometric configuration of the NF membrane may be spiral wound, plate and frame (flat sheet), hollow fiber modules, a plurality of stacked or layered sheets, nanofiller incorporated membranes, or nanofibers.

In some embodiments, the NF membrane materials may comprise cellulose ester derivatives, other polyamide type thin film composite membranes, or nanocomposite membranes.

In some embodiments, the molecular weight of the NF membrane may be in the range of 200-500 Da.

In some embodiments, the geometric configuration of the membrane of the FO module may be spiral wound, plate and frame (flat sheet), hollow fiber modules, a plurality of stacked or layered sheets, nanofillers incorporated membranes, or nanofibers. The membrane of the FO module may be operated in any suitable configuration such as cross flow, co-current, counter-current, axial or radial configurations.

In some embodiments the RO membrane materials may comprise cellulose ester derivatives or other polyamide type thin film composite membrane, or nanocomposite membranes.

In some embodiments, the geometric configuration of the RO membrane may comprise spiral wound or plate and frame (flat sheet) or hollow fiber modules or a plurality of stacked or layered sheets or nanofillers incorporated membranes or nanofibers. In some embodiments the geometric configuration of the RO membrane may consist of spiral wound or plate and frame (flat sheet) or hollow fiber modules or a plurality of stacked or layered sheets or nanofillers incorporated membranes or nanofibers.

The present invention can be implemented in any desalination industries to attain the highest water recovery and to produce the saturated brine. The present invention can be implemented in various desalination and water treatment industries such as: power generation; oil and gas; textile; food and beverage; chemical; pharmaceutical; dairy; and biorefinery.

### BRIEF DESCRIPTION OF THE DRAWINGS

The disclosure will be further described with reference to examples depicted in the accompanying figures in which:

FIG. 1 is a diagram showing an embodiment of the present invention;

FIG. 2 is a diagram showing a second embodiment of the present invention;

FIG. 3 is a diagram showing a third embodiment of the present invention;

FIG. 4 is a diagram showing a fourth embodiment of the present invention;

FIG. 5 is a diagram showing a fifth embodiment of the present invention;

FIG. 6 is a diagram showing a sixth embodiment of the present invention; and

FIG. 7 is a diagram showing a seventh embodiment of the present invention.

### DETAILED DESCRIPTION

The following description presents particular examples and, together with the drawings, serves to explain principles of the disclosure. However, the scope of the invention is not intended to be limited to the precise details of the examples, since variations will be apparent to a skilled person and are deemed to be covered by the description. Terms for components used herein should be given a broad interpretation that also encompasses equivalent functions and features. In some cases, alternative terms for structural features may be provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner.

The description herein refers to examples with particular combinations of features, however, it is envisaged that further combinations and cross-combinations of compatible features between embodiments will be possible. Indeed, isolated features may function independently as an invention from other features and not necessarily require implementation as a complete combination.

The main role of the NF module is to separate the scalant and hardness ions from the feed solution. The hardness ions cannot pass through the NF membrane. The ions such as calcium, Ca²⁺, magnesium, Mg²⁺, sulfates, SO₄²⁻, and bicarbonates, HCO₃⁻, limit the life span or reliability of FO and RO membranes by forming a scaling and fouling layer on the membrane surface. Additionally, NF treatment is effective in reducing the salinity of the feed solution and the pressure requirements in the subsequent steps. The typical operating pressure of NF is about 70-400 psi with a maximum operating pressure of about 600 psi to up to 1200 psi. The maximum pressure drop of NF is 12 psi over an element and 50 psi per housing. The typical operating flux of NF is about 13-34 L/m²h.

The FO system consists of a semipermeable membrane. The FO membrane is specially configured within the membrane module to attain high dispersion of draw solution and feed solution throughout the module to attain high permeate flow. FO membranes are thinner than RO membranes due to the non-pressure requirement of the FO process. Operating pressures of up to 70 bar and salt rejections of >99% are suitable.

The RO membrane is a semipermeable membrane. The RO membrane with typical operating pressure range of 60-80 bar and a maximum operating pressure of about 600 psi to up to 1200 psi. The salt rejection efficacy of RO should be >99%.

In the following description, similar numerals will be used for similar parts of embodiments of the present invention.

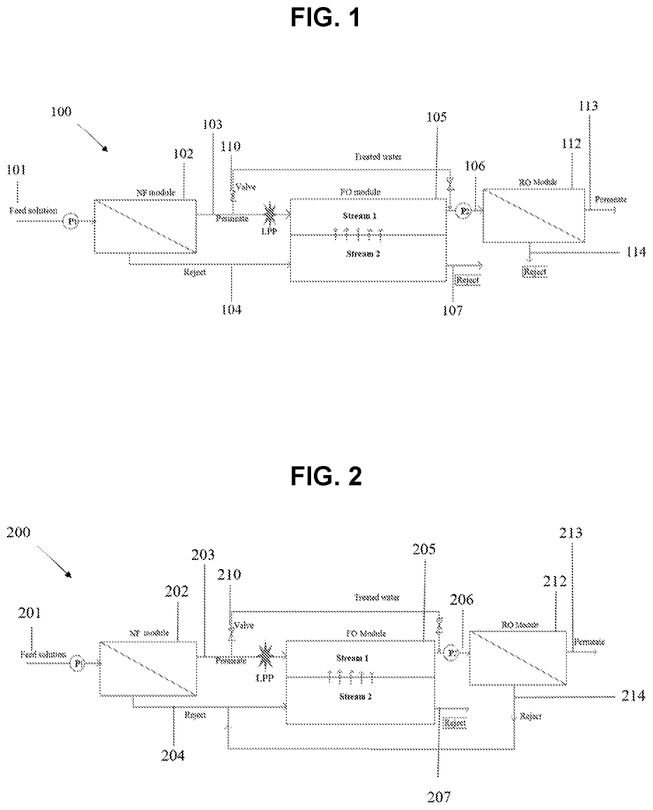

FIG. 1 illustrates a first embodiment of the invention for the treatment of saline water with a pure water recovery of 49.56%. The treatment system 100 comprises an NF module 102, an FO module 105 and an RO module 112. The feed solution 101, is inserted into the feed side of the NF module 102 using a first pressure pump P1. The NF module 102 contains a semipermeable NF membrane. The solution that passes through the semipermeable NF membrane forms the NF permeate 103, which enters Stream 1 of the FO module 105 via the low pressure pump, LPP. The solution that does not pass through the semipermeable NF membrane forms the NF reject solution 104, which enters Stream 2 of the FO module 105. Within the FO module 105 there will be transport of water molecules from Stream 2 to Stream 1 due to the dominating effect of higher hydraulic pressure existing in the Stream 2. Therefore Stream 2 will be further concentrated and will exit the FO module 105 as reject solution 107. Whereas, Stream 1 will be further diluted and leave the FO module 105 as FO permeate 106. The FO permeate 106 then enters the feed side of the RO module 112 using a second pressure pump P2. The pressure pump P2 applies hydraulic pressure in the range of 70-80 bar. The RO module 112 contains a semipermeable RO membrane. The solution that passes through the RO membrane forms the RO permeate 113. The solution that does not pass through the semipermeable membrane forms the RO reject solution 114. The RO permeate 113 is a high purity water and the RO reject 114 is a concentrated brine solution.

The system 100 also allows for the NF permeate 103 to bypass the FO module 105 using the valve 110. The NF permeate 103 then re-enters the stream after the FO module 105 and joins the FO permeate 106 before the pressure pump P2. The NF module 102 and FO module 105 provide a feed stream 106 to the RO module 112 with reduced scaling and fouling ions than a saline feed stream and allow the system 100 to provide pure water recovery of 49.56%.

FIG. 2 illustrates a second embodiment of the invention for the treatment of saline water with a pure water recovery of 58.65%. The treatment system 200 comprises an NF module 202, an FO module 205 and an RO module 212. The feed solution 201, is inserted into the feed side of the NF module 202 using a first pressure pump P1. The NF module 202 contains a semipermeable NF membrane. The solution that passes through the semipermeable NF membrane forms the NF permeate 203, which enters Stream 1 of the FO module 205 via the low pressure pump, LPP. The solution that does not pass through the semipermeable NF membrane forms the NF reject solution 204, which enters Stream 2 of the FO module 205. Within the FO module 205 there will be transport of water molecules from Stream 2 to Stream 1 due to the dominating effect of higher hydraulic pressure existing in the Stream 2. Therefore Stream 2 will be further concentrated and will exit the FO module 205 as reject solution 207. Whereas, Stream 1 will be further diluted and leave the FO module 205 as FO permeate 206. The FO permeate 206 then enters the feed side of the RO module 212 using a second pressure pump P2. The pressure pump P2 applies hydraulic pressure in the range of 70-80 bar. The RO module 212 contains a semipermeable RO membrane. The solution that passes through the RO membrane forms the RO permeate 213. The solution that does not pass through the semipermeable membrane forms the RO reject solution 214. The RO permeate 213 is a high purity water and the RO reject 214 is a concentrated reject solution. The RO reject solution 214 enters Stream 2 with the NF reject solution 204. The recirculation of the RO reject solution 214 in the system 200 increases the pure water recovery from 49.56% to 58.65%.

The system 200 also allows for the NF permeate 203 to bypass the FO module 205 using the valve 210. The NF permeate 203 then re-enters the stream after the FO module 205 and joins the FO permeate 206 before the pressure pump P2. The NF module 202 and FO module 205 provide a feed stream 206 to the RO module 212 with reduced scaling and fouling ions than a saline feed stream and allow the system 200 to provide pure water recovery of 58.65%.

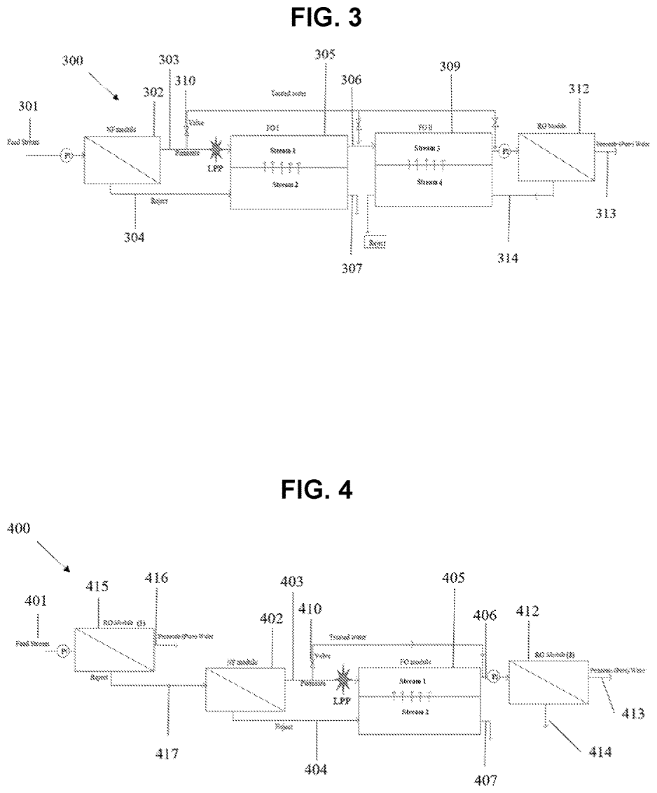

FIG. 3 illustrates a system 300 comprising a second FO module 309 after the first FO module 305. The FO permeate 306 enters Stream 3 of the second FO module 309 and the RO reject 314 enters Stream 4 of the second FO module 309. Due to the higher hydraulic pressure of the RO reject solution 314, water molecules are transferred across the semipermeable membrane from Stream 4 to Stream 3. The concentrated Stream 4 of the second FO module 309 exits the system as a reject solution. The connection of two FO systems in series in the system 300 provides pure water recovery of the system 300 of 55.65% starting from the seawater feed solution 301.

FIG. 4 illustrates a system 400 similar to the system 100 of FIG. 1 wherein the system 400 further comprises an RO module 415 between the first pressure pump P1 and the NF module 402. The RO permeate 416 leaves the system 400 as pure water and the RO reject 417 enters the inlet of the NF module 402. The system 400 provides a pure water recovery of 57.82%.

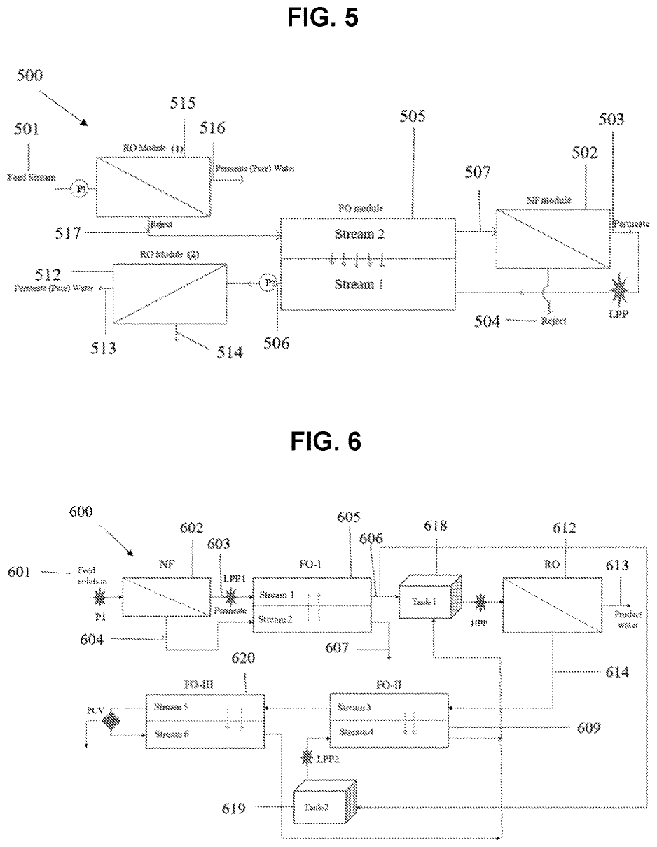

FIG. 5 illustrates a system 500 comprising a feed solution 501, a first pressure pump P1, an initial RO module 515, an FO module 505, an NF module 502, a second pressure pump P2, and an RO module 512. The feed solution 501 is delivered to the initial RO module 515 via the first pressure pump P1 which applies hydraulic pressure of 70 bar. The solution 501 is separated at the initial RO module 515 into an RO permeate 516 which leaves the system 500 as pure water, and an RO reject solution 517 which is delivered to Stream 2 of the FO module 505. Within the FO module 505 there is transport of water molecules from Stream 2 to Stream 1 due to the dominating effect of higher hydraulic pressure of approximately 68 bar existing in Stream 2. Therefore Stream 2 will be further concentrated and will exit the FO module 505 as reject solution 507. Whereas, Stream 1 will be further diluted and leave the FO module 505 as FO permeate 506. The FO reject solution 507 is delivered to the NF module 502, at a hydraulic pressure of approximately 68 bar, where the solution is separated into NF reject solution 504 which leaves the system 500, and a an NF permeate solution 503 which is delivered to Stream 1 of the FO module 505 via the low pressure pump, LPP. The diluted FO permeate solution 506 is delivered to the RO module 512 via the second pressure pump P2 which applies a hydraulic pressure of 70 to 80 bar. At the RO module 512, the solution is separated into an RO permeate solution 513 which leaves the system 500 as pure water, and an RO reject solution 514 which leaves the system 500. The system 500 gives a pure water recovery of 62.6% from seawater. The process uses a single input stream. The RO reject solution 514 is highly concentrated and suitable for a mineral extraction process leading to a zero liquid discharge process.

FIG. 6 illustrates a system 600 comprising a feed solution 601, a first pressure pump P1, an NF module 602, a first low pressure pump LPP1, a first FO module 605, a first tank 618, a high pressure pump HPP, an RO module 612, a second FO module 609, a second tank 619, a second low pressure pump LPP2, a third FO module 620 and a pressure control valve PCV. The first pressure pump P1 delivers the feed solution 601 to the NF module 602 at a hydraulic pressure of 20 to 40 bar. At the NF module 602 the solution is separated into an NF permeate 603 and an NF reject 604. The NF permeate 603 is delivered by a low pressure pump LPP1 at a hydraulic pressure of 2 to 5 bar to Stream 1 of the FO module 605. The NF reject solution 604 enters Stream 2 of the FO module 605. Within the FO module 605 there is transport of water molecules from Stream 2 to Stream 1 due to the dominating effect of higher hydraulic pressure existing in Stream 2. Therefore Stream 2 will be further concentrated and will exit the FO module 605, the system 600, as reject solution 607. Whereas, Stream 1 will be further diluted and leave the FO module 605 as FO permeate 606. The FO permeate 606 is transferred to the first tank 618 and the second tank 619. The high pressure pump HPP delivers the solution from the first tank 618 to the RO module 612 where the solution is separated into an RO permeate 613 and an RO reject 614. The RO permeate 613 leaves the system 600 as treated water and the RO reject 614 enters Stream 3 of the second FO module 609. The solution from the second tank 619 is delivered to Stream 4 of the second FO module 609 via the low pressure pump LPP2 at a hydraulic pressure of 2 to 5 bar. Therefore within the second FO module 609 there is a transport of water molecules from Stream 3 to Stream 4 due to the higher hydraulic pressure of Stream 3. The concentrated Stream 3 solution is delivered to Stream 5 of the third FO module 620 at a high hydraulic pressure of 40 to 70 bar. Stream 5 exits the third FO module 620 as highly concentrated reject solution which is partially delivered to Stream 6 via a pressure control valve PCV at a lower hydraulic pressure. Therefore within the third FO module 620, there is transport of water molecules from Stream 5 to Stream 6. The diluted solutions from Stream 4 of the second FO module 609 and Stream 6 of the third FO module 620 are delivered to the first tank 618 to be delivered to the RO module 612 via the high pressure pump HPP. The process increases the concentration of the reject solution released by the pressure control valve PCV to saturation level. The pure water recovery of the process is up to 68.6%. The process uses a single input to give high water recovery. The process also produces a single highly concentrated reject solution suitable for mineral extraction leading to a zero liquid discharge process.

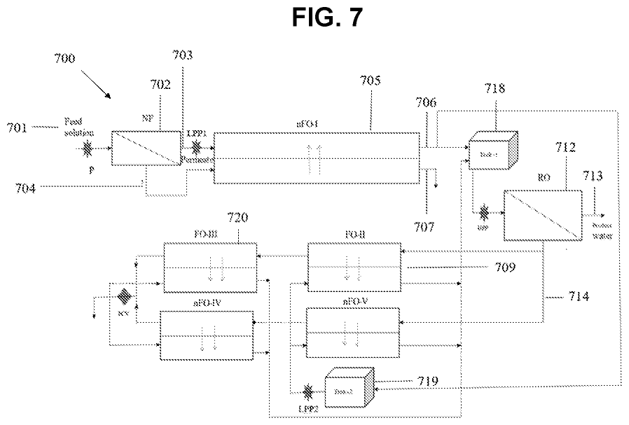

FIG. 7 illustrates a system 700 similar to system 600. System 700 further comprises n pairs of FO modules which are configured in the same way as the second and third FO modules 609 and 620 of system 600. The number of pairs of FO modules, n, is an integer and the water recovery of the system increases as n increases. The system 700 further increases the concentration of the reject solution and increases the pure water recovery to up to 80.28%.

The invention is not limited to the specific examples or structures illustrated; a greater number of components than are illustrated in the Figures could be used, for example. There could be an increased number of RO modules, FO modules or NF modules. The system could comprise an increased number of feed solutions. The system could also comprise forward osmosis modules.

1. A saline water treatment system comprising: an inlet for receiving a feed solution, a first pressure pump for delivering the feed solution to a separation module, a forward osmosis, FO, module, a second pressure pump, and a reverse osmosis, RO, module;
the separation module comprising an inlet for receiving the feed solution from the first pressure pump, a membrane defining a permeate portion and a reject portion of the module, a first outlet in the permeate portion and a second outlet in the reject portion;
the FO module comprising a first and second portion separated by a semipermeable membrane, wherein each portion of the FO module comprises an inlet and an outlet;
wherein the system is configured to separate the feed solution in the separation module into a permeate solution with a reduced ion concentration and a reject solution with an increased ion concentration, the reject solution leaving the separation module at a higher hydraulic pressure than the permeate solution due to the assistance of hydraulic pressure applied at the first pressure pump;
wherein the system is further configured to deliver a first solution to the first portion of the FO module and to deliver the reject solution from the separation module to the second portion of the FO module, to facilitate the transport of water molecules across the semipermeable membrane from the second portion to the first portion;
wherein the system is configured to output a FO permeate solution from the first portion of the FO module and a concentrated FO reject solution from the second portion of the FO module; and
wherein the system is further configured to deliver the FO permeate solution via a second pressure pump to the RO module, the RO module comprising an inlet for receiving the FO permeate solution, a RO membrane defining a RO reject portion and a RO permeate portion of the RO module, a first outlet in the RO reject portion and a second outlet in the RO permeate portion.

2. The saline water treatment system of claim 1, wherein the separation module is a nanofiltration, NF, module; the NF module comprising an inlet for receiving the feed solution from the first pressure pump, a NF membrane defining a NF permeate portion and a NF reject portion of the NF module, a first outlet in the NF permeate portion, and a second outlet in the NF reject portion.

3. The saline water treatment of claim 1, wherein the separation module is a RO module, the RO module comprising an inlet for receiving the feed solution, a RO membrane defining a RO reject portion and a RO permeate portion of the RO module, a first outlet in the RO reject portion and a second outlet in the RO permeate portion.

4. The saline water treatment system of claim 1, wherein the first solution delivered to the first portion of the FO module is the permeate solution from the separation module.

5. The saline water treatment system of claim 1, wherein the RO reject solution is delivered to the second portion of the FO module.

6. The saline water treatment system of claim 1, wherein the system further comprises a second FO module, the second FO module comprising a first and second portion separated by a semipermeable membrane, wherein each portion of the FO module comprises an inlet and an outlet.

7. The saline water treatment system of claim 6, wherein the first portion of the second FO module is configured to receive the FO permeate solution from the first FO module and the second portion of the second FO module is configured to receive the reject solution from the RO module.

8. The saline water treatment system of claim 1, wherein the system further comprises a second separation module located before the first separation module, the second separation module comprising a membrane defining a permeate portion and a reject portion of the module, a first outlet in the permeate portion and a second outlet in the reject portion, the second separation module configured to separate the feed solution into a permeate solution and a reject solution, and wherein the reject solution of the second separation module is delivered to the inlet of the first separation module.

9. The saline water treatment system of claim 8, wherein the second separation module is a RO module.

10. The saline water treatment system of claim 1, wherein the system comprises an NF module, the NF module comprising an inlet, a NF membrane defining a NF permeate portion and a NF reject portion of the NF module, a first outlet in the NF permeate portion, and a second outlet in the NF reject portion; wherein the system is configured to deliver the FO reject solution to the NF module, the NF module is configured to separate the FO reject solution into a NF reject solution and a NF permeate solution, and the system is configured to deliver the NF permeate solution to the first portion of the FO module.

11. The saline water treatment system of claim 1, wherein the feed solution comprises at least one selected from the group consisting of: seawater, brackish water, industrial sewage water, domestic sewage water, storm sewage water, produced water, and oil field produced water.

12. The saline water treatment system of claim 1, wherein the system further comprises a valve configured to allow the controlled bypass of modules by the permeate solutions.

13. The saline water treatment system of claim 1, wherein the system comprises a low pressure pump configured to deliver the solution to the first portion of the first and/or second FO module at a reduced pressure.

14. The saline water treatment system of claim 1, wherein the system further comprises: a first tank, a second tank, a high pressure pump, a low pressure pump, a pair of FO modules comprising a second FO module and a third FO module, and a pressure control valve; wherein the system is configured to:
deliver the FO permeate solution from the first FO module to the first and second tanks;
deliver the solution from the first tank via the high pressure pump to the RO module at an increased hydraulic pressure, and deliver the solution from the second tank via the low pressure pump to the second portion of the second FO module at a reduced pressure;
deliver the RO reject solution to the first portion of the second FO module, deliver the reject solution from the second FO module to the first portion of the third FO module;
deliver the reject solution of the third FO module to the second portion of the third FO module via the pressure control valve, the pressure control valve configured to lower the pressure of the solution; and
deliver the reject solution of the third FO module to the first tank.

15. The water treatment system of claim 14, wherein the system further comprises one or more additional pairs of FO modules.

16. The saline water treatment system of claim 1, wherein the system comprises a single feed stream.

17. The saline water treatment system of claim 1, wherein the system comprises a single reject output stream.
